(19) United States
(12) Patent Application Publication
(10) Pub. No.: US 2013/0205019 A1
(43) Pub. Date: Aug. 8, 2013

(54) SYSTEMS AND METHODS FOR MANAGING API INTERACTIONS

(71) Applicant: William Oellermann, Dallas, TX (US)

(72) Inventor: William Oellermann, Dallas, TX (US)

(21) Appl. No.: 13/760,891

(22) Filed: Feb. 6, 2013

Related U.S. Application Data
(60) Provisional application No. 61/595,939, filed on Feb. 7, 2012.

(51) Int. Cl. H04L 12/26

(52) U.S. Cl. CPC H04L 43/50
USPC 709/224; 709/225

(57) ABSTRACT

Systems and methods for enabling and managing API interactions through one or more location-agnostic software brokers interchangeably on premises as well as in a cloud environment are provided. These systems and methods may include a tree-based hierarchy of hypermedia components and additional metadata to enable comparisons between distinct APIs accessed via various and wide-ranging protocols. These systems and methods may provide portability across relational and non-relational data stores to support hybrid and location-specific installations of software brokers and allow users to access and leverage on-premises (e.g., private) model entities side-by-side with off-premise (e.g., public or cloud) model entities. Flexibility across model entities may provide portability and sharing across multiple environments, thereby providing a highly leveraged environment that may reduce duplication of efforts in the management of API interactions.

### CROSS-REFERENCE TO RELATED APPLICATION

The present application claims the benefit under 35 U.S.C. §119(e) of U.S. Provisional Patent Application Ser. No. 61/595,939 filed Feb. 7, 2012 and entitled “Systems and Methods for Managing API Interactions,” which is incorporated herein by reference for all purposes.

### FIELD OF THE DISCLOSURE

The present disclosure generally relates to systems and methods for managing API interactions, and more particularly to systems and methods for managing API interactions interchangeably through on-premises, multi-tenant and/or cloud-based environments.

### BACKGROUND

Computers and computing systems are utilized in various aspects of business, and the functionality of these computers and computing systems may be enhanced through network connections. Such network connections may allow for computers and computing systems to be interconnected, and network connections may include, but are not limited to, wired or wireless Ethernet, cellular connections, as well as serial, parallel, USB and other connections. These network connections allow computers and computing systems to access and/or receive services or application programming interfaces (APIs) at or from other computing systems. API management may involve publishing and managing APIs typically through API management systems. Such systems may help API publishers to create new applications based on the APIs that they publish and may govern or meter access to and usage of APIs, help developers discover APIs, and/or secure APIs against abuse or attack.

### SUMMARY

Embodiments of the present disclosure may provide systems and methods for enabling and managing API interactions interchangeably on premises as well as in a cloud environment. These systems and methods may provide portability across relational and non-relational data stores to allow users to access and leverage on premises model entities side-by-side with multi-tenant and/or cloud-based model entities.

Systems and methods of enabling and managing API interactions may provide for monitoring, testing, brokering, and/or storing information related to APIs. Monitoring may provide for service-level observations as proxy for what the API user may be experiencing. Testing may be used to simulate a call to an API so that the results may be evaluated. Brokering may be employed to facilitate a connection between an application and an API in order to provide a single view between internal and external API activity. Storing data related to API management also may occur interchangeably between multiple cloud environments as well as on premises.

### BRIEF DESCRIPTION OF THE DRAWINGS

For a more complete understanding of this disclosure, reference is now made to the following description, taken in conjunction with the accompanying drawings, in which:

FIG. 1a depicts defining a request of an API according to an embodiment of the present disclosure;

FIG. 1b depicts viewing the response of an API according to an embodiment of the present disclosure;

FIG. 1c depicts a test call message system according to an embodiment of the present disclosure;

FIG. 1d depicts an automated call process according to an embodiment of the present disclosure;

FIG. 2 depicts an on-premise API management process according to an embodiment of the present disclosure;

FIG. 3 depicts a multi-tenant API management process according to an embodiment of the present disclosure;

FIG. 4 depicts a hybrid API management process according to an embodiment of the present disclosure;

FIG. 5 depicts how reports may be created to manage API interactions according to an embodiment of the present disclosure;

FIG. 6 depicts results of test calls executed across a set of APIs from multiple environments according to an embodiment of the present disclosure;

FIG. 7 depicts viewing a summary of test calls executed across different environments according to an embodiment of the present disclosure;

FIG. 8 depicts a view of selected APIs distributed across multiple public and private systems according to an embodiment of the present disclosure;

FIG. 9 depicts a view of APIs across multiple public and private systems through a single console according to an embodiment of the present disclosure; and

FIG. 10 depicts creation of an API alert according to an embodiment of the present disclosure.

### DETAILED DESCRIPTION

Traditionally, APIs have been managed in the cloud environment or on premises through a hardware server; however, API management systems have suffered from not being able to manage APIs, such as for testing, discovery and/or other management of APIs, interchangeably in a cloud environment as well as on premises through the same system or method. Prior systems and methods may be less efficient in that the API management software running on premises may know nothing about API management occurring in the cloud environment. Further, such prior systems and methods may be more costly to operate in that a user may pay a license to run software on premises while also paying for API management within the cloud environment.

Embodiments of the present disclosure may provide systems and methods for enabling and managing API interactions through location-agnostic software brokers interchangeably on premises such as through a hardware server and/or through one or more cloud-based environments. Systems and methods according to embodiments of the present disclosure may include a tree-based hierarchy of hypermedia components to enable comparisons between distinct APIs. These systems and methods may provide portability across relational and non-relational data stores to support hybrid and location-specific installations of software brokers and allow users to access and leverage on-premises (e.g., private) model entities side-by-side with off-premise (e.g., public or cloud) model entities. Flexibility across model entities according to embodiments of the present disclosure may provide portability and sharing across multiple environments, thereby providing a highly leveraged environment that may reduce duplication of efforts in management of API interactions.

“On-premises” according to embodiments of the present disclosure may refer to any software or data that may be stored within the physical boundaries of an organization. In contrast, a cloud environment may include location-independent computing where shared servers provide resources, software and/or data to computers and other devices on demand. In a cloud environment, computers may be shared but each user would still have its own data, and network access may be rapidly provisioned and related with minimal management interaction. A cloud environment also may be referred to as a multi-tenant system (as described in more detail below with respect to FIG. 3) wherein a single instance of the software may run a server and serve multiple client organizations. In a multi-tenant system, a software application may virtually partition its data and configuration, and each client organization may work with a customized virtual application instance. Multiple users may share the same application, running the same operating system, on the same hardware, with the same data-storage mechanism. However, users may be distinguished in that the users do not share or see each other's data. Accordingly, the data and processing for multiple clients may be commingled in a single application instance. As an example, popular user-oriented web applications, such as Facebook or Hotmail, are designed as single application instances that may serve all users, and multi-tenant systems may offer additional customization to a group or users within the same client organization. Multi-tenant systems may allow for increased efficiency and cost savings in that it simplifies administration and provisioning of tenants. Data may be easier to segregate and analyze across tenants because all tenants may share the same database scheme. This may be contrasted with a multi-instance architecture where separate software instances (or hardware systems) may be set up for different client organizations.

API management according to embodiments of the present disclosure may be performed both in the cloud environment as well as on premises, thereby allowing a user to switch interchangeably between a cloud (or multi-tenant) environment and on premises to manage API interactions. Having the ability to switch between the cloud environment and on premises to manage API interactions may allow a user to leverage resources in the cloud environment for testing, discovery and/or management of APIs while maintaining a desired level of management on premises using the same system or method. Such leveraging may provide API management that may be more efficient and cost-effective, for example, because no new virtual machine instances may be needed and/or less maintenance may be required.

Embodiments of the present disclosure may provide for management of API interactions through, including, but not necessarily limited to, monitoring, testing, brokering, and/or storing information related to APIs. Each of these aspects of API management will be briefly described.

In an embodiment of the present disclosure, monitoring may be performed at an API boundary level to gain a better understanding of the experience of the user. It should be appreciated that various items may be monitored according to embodiments of the present disclosure, including but not necessarily limited to, time to respond, success, message size, and/or validation of response (i.e., whether a response is right or wrong). Monitoring according to embodiments of the present disclosure may provide for service-level observations such that what is observed may serve as a proxy for what the user of the API may be experiencing. It should be appreciated that monitoring according to embodiments of the present disclosure may be attached to existing web traffic without departing from the present disclosure.

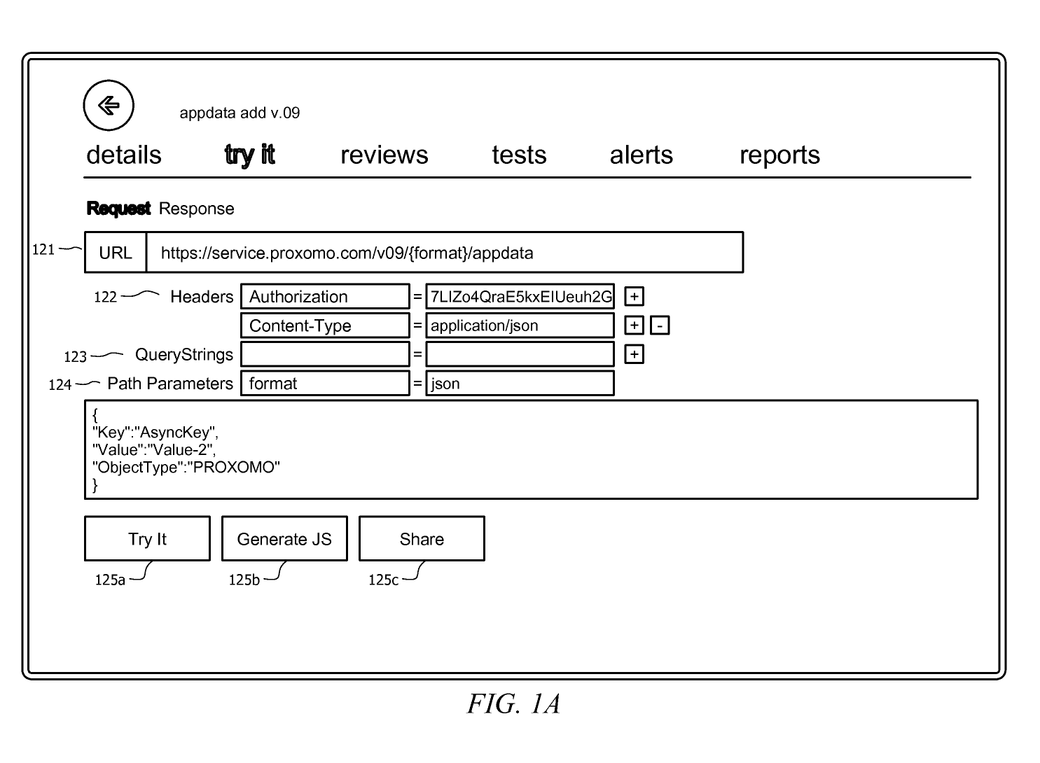

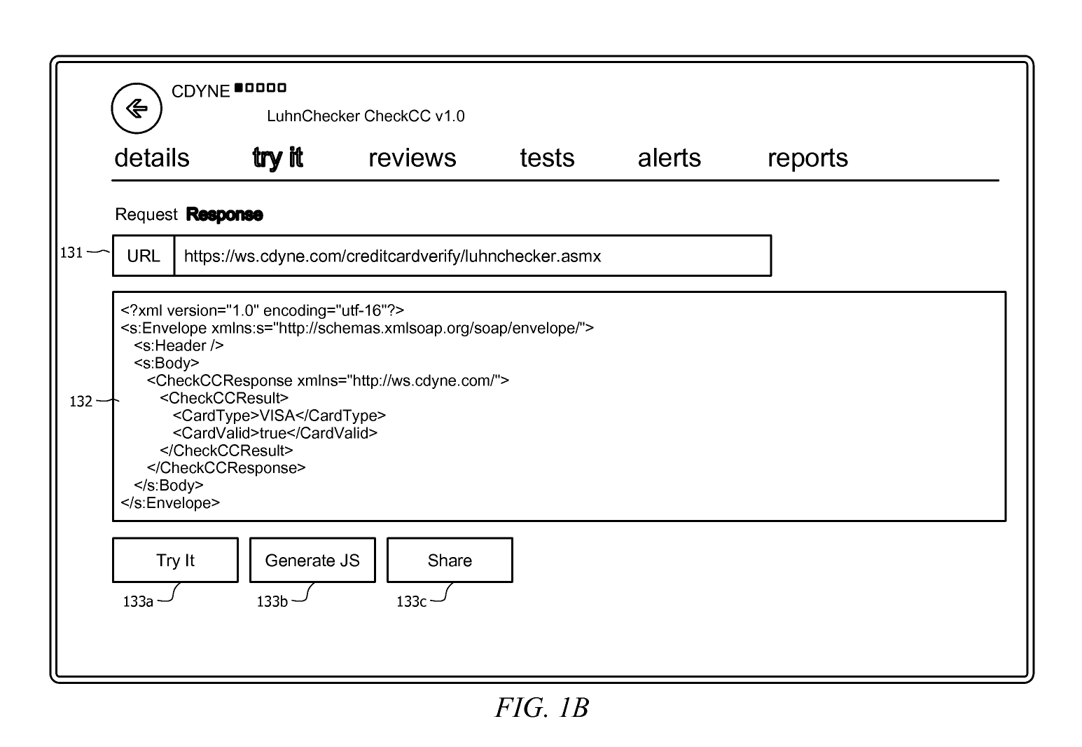

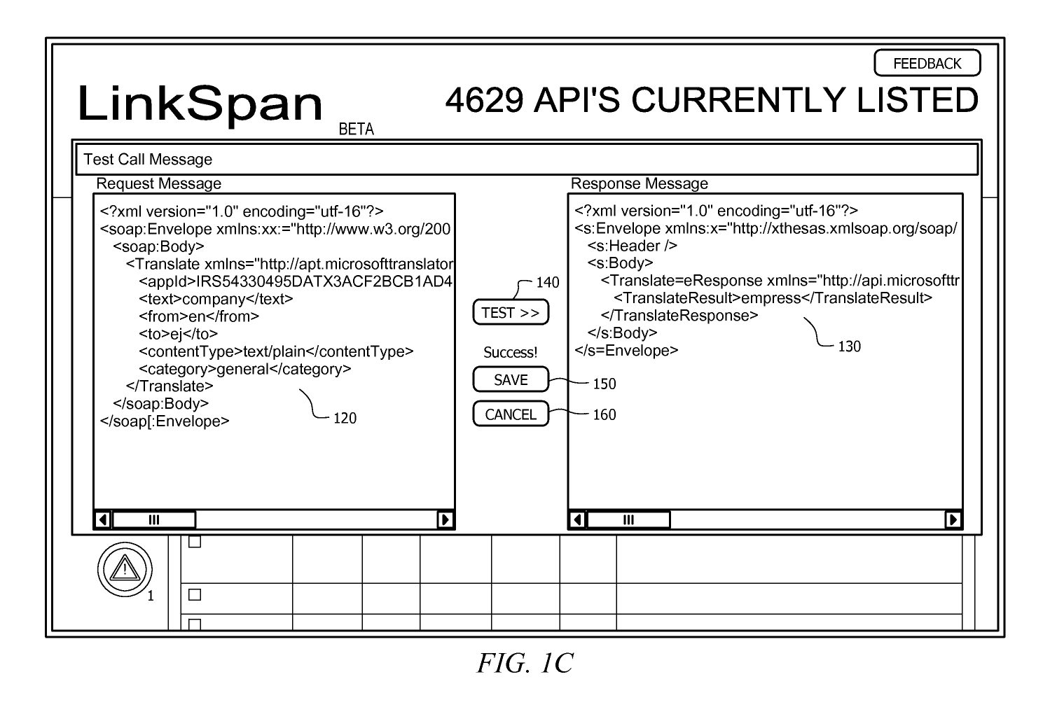

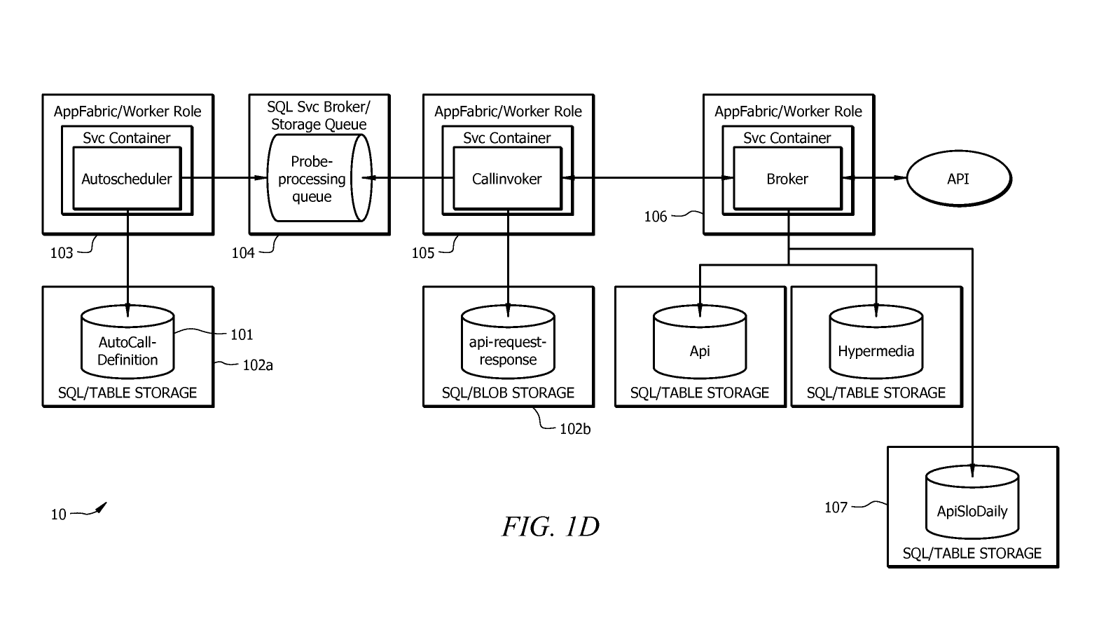

Testing within the context of API management may be done in an automated manner according to embodiments of the present disclosure. As an example, testing may include a pro-active independent test that may simulate a call to an API. Utilizing systems and methods according to embodiments of the present disclosure, an API may be tested by hitting the API at different times with the exact payload that a user might send and then evaluating the results of such a test. FIG. 1c depicts a test call message system according to an embodiment of the present disclosure. Request message 120 is depicted in FIG. 1c, and response message 130 also is depicted. Test call message system 10 may include buttons or other selection mechanisms to initiate the test call message (140), save the test call message (150) and/or cancel the test call message (160) according to embodiments of the present disclosure. It should be appreciated that testing may be performed in the cloud and/or on premises. In an embodiment of the present disclosure, a tester may test third-party APIs in the cloud while testing internal APIs on premises, and the “cloud” and “on premises” testing may be aggregated to create a single view of what may be occurring with respect to the APIs.

FIG. 1a depicts defining a request of an API according to an embodiment of the present disclosure, and FIG. 1b depicts viewing the response of an API according to an embodiment of the present disclosure. In FIG. 1a, a URL may be entered in box 121. Headers 122 may include one or more selections including but not limited to authorization or content type information. Query strings may be entered in box 123, and in path parameters 124 the format may be provided, such as json, according to an embodiment of the present disclosure. Selector boxes 125a, 125b, and 125b may be provided so that a user may opt to try the request 125a, generate javascript (JS) 125b or share 125c according to an embodiment of the present disclosure. It should be appreciated that there may be one or more selector boxes provided without departing from the present disclosure. In FIG. 1b, a URL may be provided in box 131 and response 132 may provide the response of the API according to an embodiment of the present disclosure. Similar to FIG. 1a, one or more selector boxes 133a, 133b, 133c also may be provided.

An embodiment of the present disclosure may be directed to testing, such as automated call (also referred to as “autocall”) process 10 as depicted in FIG. 1d. In step 101, an API may be created along with hypermedia data for as many APIs as are to be invoked through autocall process 10. The autocall definition may be entered into storage, such as SQL/table storage, in step 102a. It should be appreciated that the autocall definition may provide that a message may be sent to the API that may be in the cloud or on premises according to embodiments of the present disclosure. Similarly, request-response messages, such as api-request-response, may be entered into storage, such as SQL/blob storage, in step 102b. In step 103, a service container may generate scheduled activity using, for example, an AutoScheduler within the service container. The AutoScheduler may be programmed to check for active calls based on interval and/or last time called. It should be appreciated that step 103 may be performed with Windows AppFabric, a part of the Microsoft Windows Platform, to provide computing services. Additionally or alternatively, a worker role hosted through the Microsoft Windows Azure Platform may be used to perform step 103. While the Microsoft Windows Azure Platform may be referenced with respect to certain embodiments of the present disclosure, it should be appreciated that other platforms, such as non-Microsoft-based platforms, may be used without departing from the present disclosure. In step 104, active calls may be entered into a queue, such as a SQL service broker for on-premises or a storage queue in the cloud, that may contain a probe-processing queue. It should be appreciated that the autocall definition may include the updated time last called.

A persisent CallInvoker may be included in a service container under the control of AppFabric for on-premises or a worker role in the cloud. The CallInvoker may take active calls that have been entered into the queue (104), look up request-response data contained in storage (102b), and invoke test projection hosted by a broker in step 105. It should be appreciated that the broker may be included in a service container and may be under control of AppFabric or a Worker Role. In step 106, the broker may invoke an API based on a client defined in storage. It should be appreciated that the broker may draw from a SQL/table storage to pull the API and from a different SQL/table storage to pull hypermedia data according to embodiments of the present disclosure. In step 107, upon response, the broker may add a results record to ApiSloDaily contained in SQL/table storage.

Brokering is another form of API management according to embodiments of the present disclosure. Brokering may be employed to facilitate a connection between an application and an API in order to provide a single view between internal and external API activity. Location-agnostic brokering may allow applications using disparate protocols to communicate with APIs that utilize matching and non-matching protocols, security models, and/or data contracts. It should be appreciated that brokering may be between an external application and an internal API or between an internal application and an external API according to embodiments of the present disclosure. External applications or APIs may be located in a cloud environment while internal applications or APIs may be located on premises. A user may change the protocol or the payload to enrich/improve the connection as well as to even make a connection possible. It should be appreciated that brokering may employ an internal instance to communicate with an external API or application to reach third-party APIs (i.e., cross-boundary communication). Tunneling also may be used to penetrate a firewall in brokering according to embodiments of the present disclosure.

Storing is another form of API management that may be done interchangeably in a cloud environment and/or on premises according to embodiments of the present disclosure. Such interchangeability may optimize performance in both environments insofar as one set of logic may be residing both in the cloud environment as well as on premises without departing from the present disclosure. If data is to be stored in a cloud environment, it should be appreciated that denormalized storage on a mass scale without SQL may be used according to embodiments of the present disclosure. However, for data stored on premises, relational data storage or SQL may be used. It should be appreciated that while certain types of storage have been identified, other databases or storage devices may be used to store and retrieve APIs and related information without departing from the present disclosure, including but not limited to, physical storage media such as hard drives, RAM, ROM, EEPROM, CD-ROM, flash memory devices, tape, floppy disks, optical disk storage, magnetic disk storage, magnetic storage devices, or any other media that may be used to store, for example, computer-executable instructions or data structures, and may be accessed by a general purpose or special-purpose computing device.

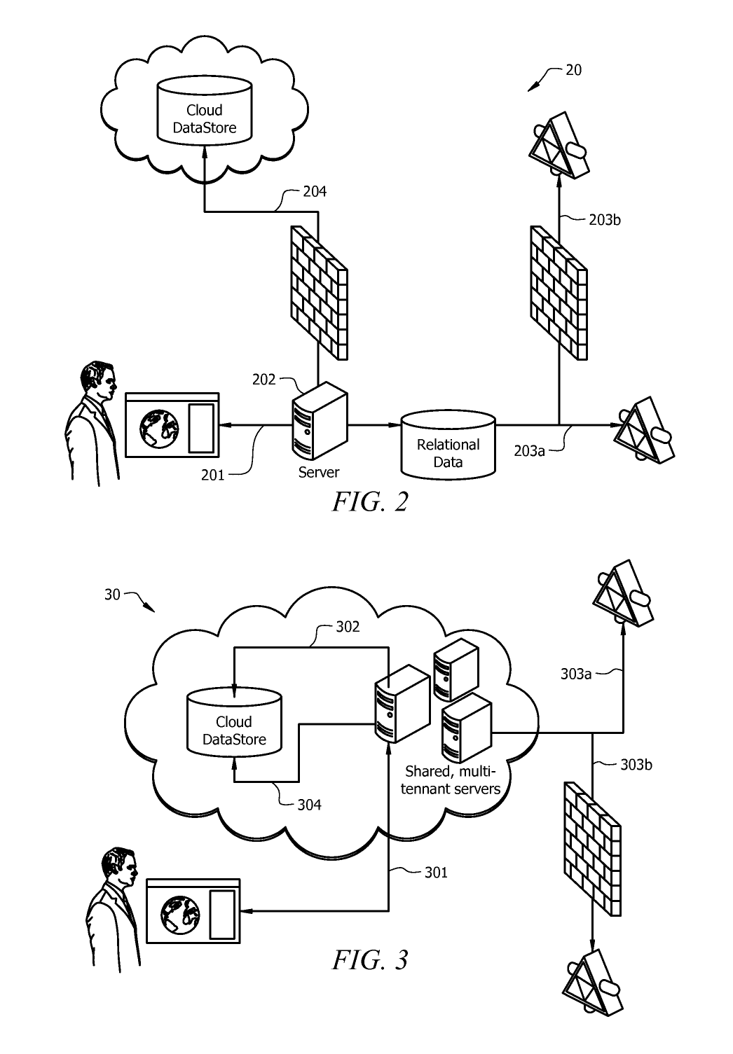

FIG. 2 depicts on-premise API management process 20 according to an embodiment of the present disclosure. A user may access a portal, such as a LinkSpan developer portal, from a local server in step 201. The local server may store all user-specific data in a local relational datastore in step 202. In step 203a, by accessing the local server, the user may import and test local services. In step 203b, accessing the local server, the user may import and test third-party services. In step 204, using a local server, a user may access a cloud-based API repository to discover and evaluate third-party APIs and add API selections to a local repository. It should be appreciated that the portal accessed by a user in step 201 may continue to function using locally available resources even if the user has no Internet access. It should be appreciated that in such an instance, the user may be able to import and test local services (step 203a) but would be unable to access to the cloud-based API repository (step 204) or import and test third-party services (step 203b).

FIG. 3 depicts multi-tenant API management process 30 according to an embodiment of the present disclosure. In process 30, API management may be conducted through one or more multi-tenant server clusters. A user may access a portal, such as LinkSpan developer portal, from a shared, multi-tenant server cluster in step 301. In step 302, the shared, multi-tenant server cluster may store all user-specific data in a shared, multi-tenant, cloud-hosted datastore. In step 303a, accessing the shared, multi-tenant server cluster, the user may import and test third-party APIs. In step 303b, accessing the same shared, multi-tenant server cluster, the user may import and test publicly accessible enterprise APIs. In step 304, using the shared, multi-tenant server cluster, a user may access a public API repository to discover and evaluate third-party APIs and add API selections to the shared, multi-tenant, cloud-hosted datastore. It should be appreciated that the portal accessed by a user in step 301 may not function if there is no Internet access as the user would not be able to access the shared, multi-tenant server cluster that may operate in the cloud.

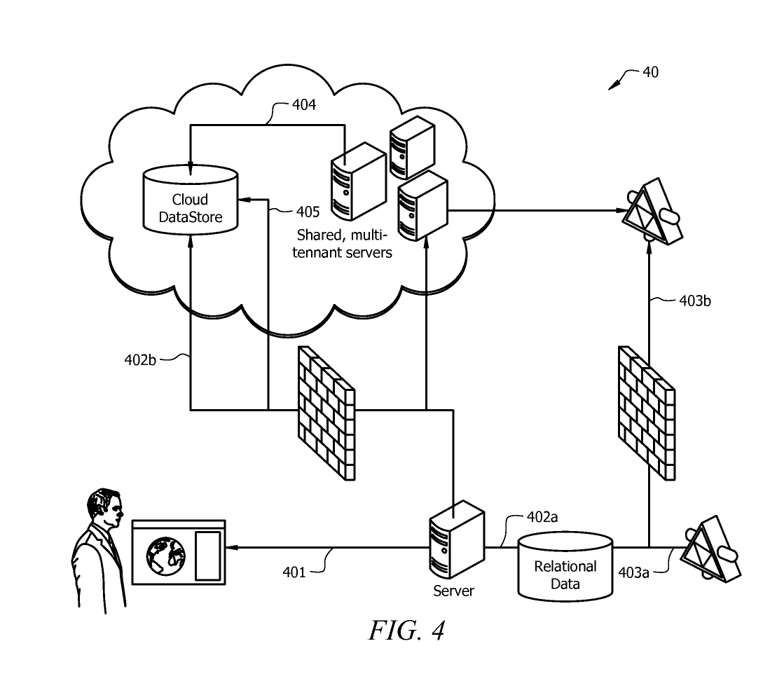

A hybrid API management system and method according to embodiments of the present disclosure may be utilized to maintain data associated with any API in any location, including APIs that are internal (i.e., inside the firewall) as well as APIs that are external, depending on the needs of the user. FIG. 4 depicts hybrid API management process 40 according to an embodiment of the present disclosure. In step 401, a user may access a portal, such as a LinkSpan developer portal, from a local server. In step 402a, the local server may store some user-specific data in a local relational datastore. The local server also may store some user-specific data in a shared, multi-tenant, cloud-hosted datastore in step 402b. In step 403a, accessing the local server, the user may import and test local APIs. The local server also may be accessed to allow the user to import and test third-party APIs in step 403b. It should be appreciated that, in step 404, the local server may communicate with a shared, multi-tenant server cluster to allow the user to access and test third-party APIs. In this step, the shared, multi-tenant server cluster may access a shared, multi-tenant, cloud-hosted datastore. The local server also may access a cloud-based or public API repository to discover and evaluate third-party APIs and add API selections to a local repository in step 405. It should be appreciated that the portal accessed by a user in step 401 may continue to function using locally available resources if there is no Internet access according to embodiments of the present disclosure. For example, if there is no Internet access, the shared, multi-tenant cloud-hosted datastore where some user-specific data may be stored in step 402b would not be available. It follows that a user would not be able to import and test third-party APIs (step 403b) or access the cloud-based API repository (step 405) without Internet access.

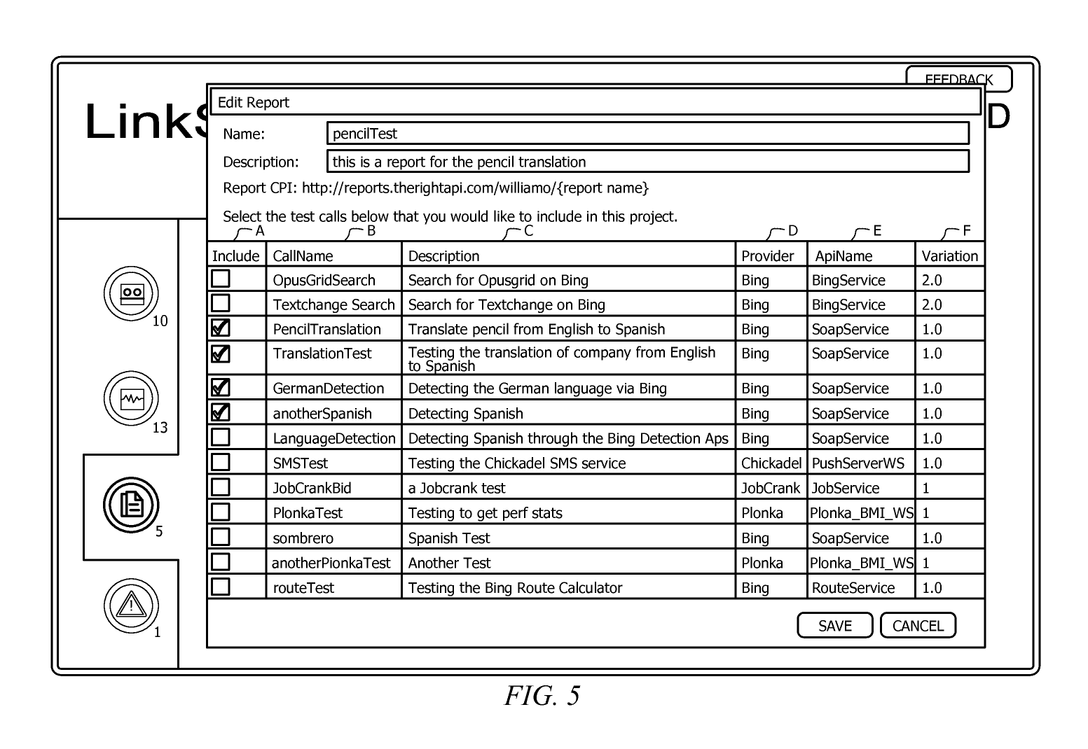

It should be appreciated that API interactions may be managed through creation and evaluation of reports according to embodiments of the present disclosure. FIG. 5 depicts how reports may be created to manage API interactions according to an embodiment of the present disclosure. A user may select test calls to be included in a certain API management project. Column A of the selection matrix may provide a user with the ability to select various call names to be included in a project, through checkboxes or another similar selection mechanism. Column B may provide the call name. Column C may describe the call, and Column D may identify the provider. The API name may be identified in Column E, and the version may be specified in Column F. While Columns A-F may be included in the selection matrix as depicted in FIG. 5, it should be appreciated that more, fewer, or even different columns may be made available for selection without departing from the present disclosure. Further, the columns may be arranged in a different order without departing from the present disclosure. It also should be appreciated that a user's selections within the matrix may be saved, and the report may be named or described.

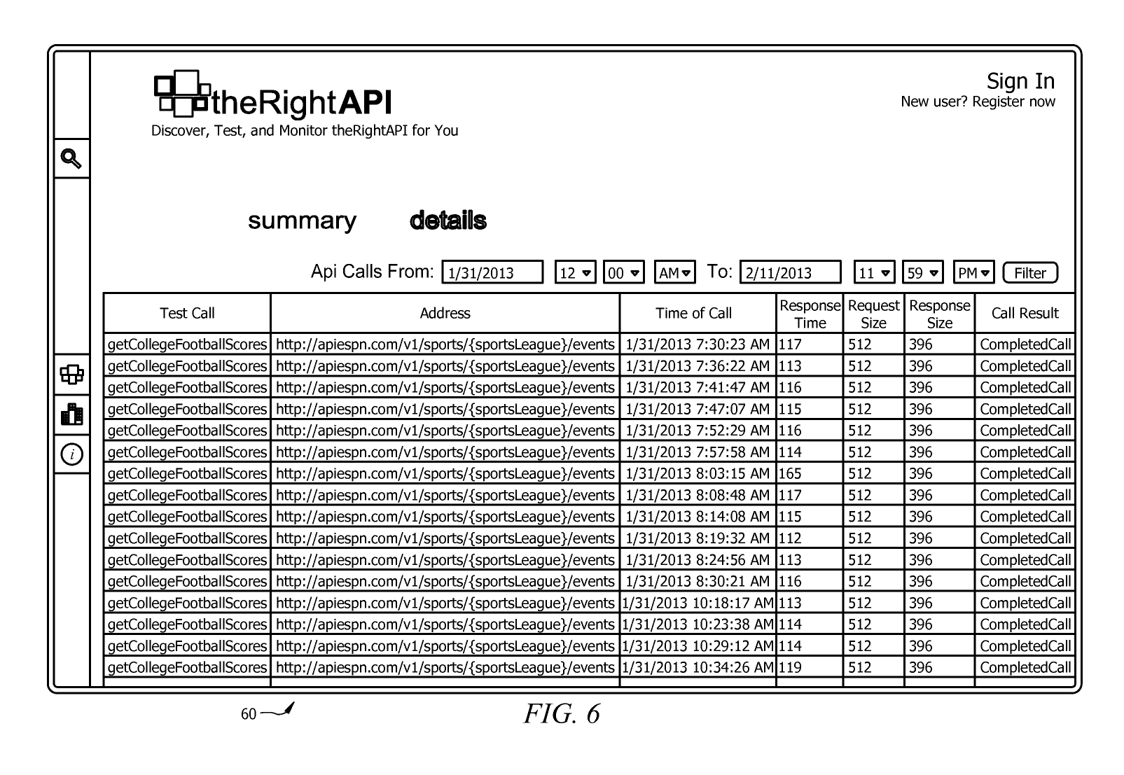

FIG. 6 depicts a a view of the results of test calls executed across a set of APIs from multiple environments according to an embodiment of the present disclosure. In this embodiment, the parameters have been set to identify/list API calls over a period starting on Jan. 31, 2013 at around 7:30 am and continuing until Jan. 31, 2013 at around 10:34 am. It should be appreciated that the date and time parameters may be filtered or otherwise modified to provide a smaller or larger range of dates/times without departing from the present disclosure. In an embodiment of the present disclosure, the report may include information, including but not limited to, the type of test call, the address, time of call, response time, request time, response size, and/or call result. However, it should be appreciated that more or fewer fields may be included in the detail report without departing from the present disclosure. Further, the columns may be arranged in a different order without departing from the present disclosure.

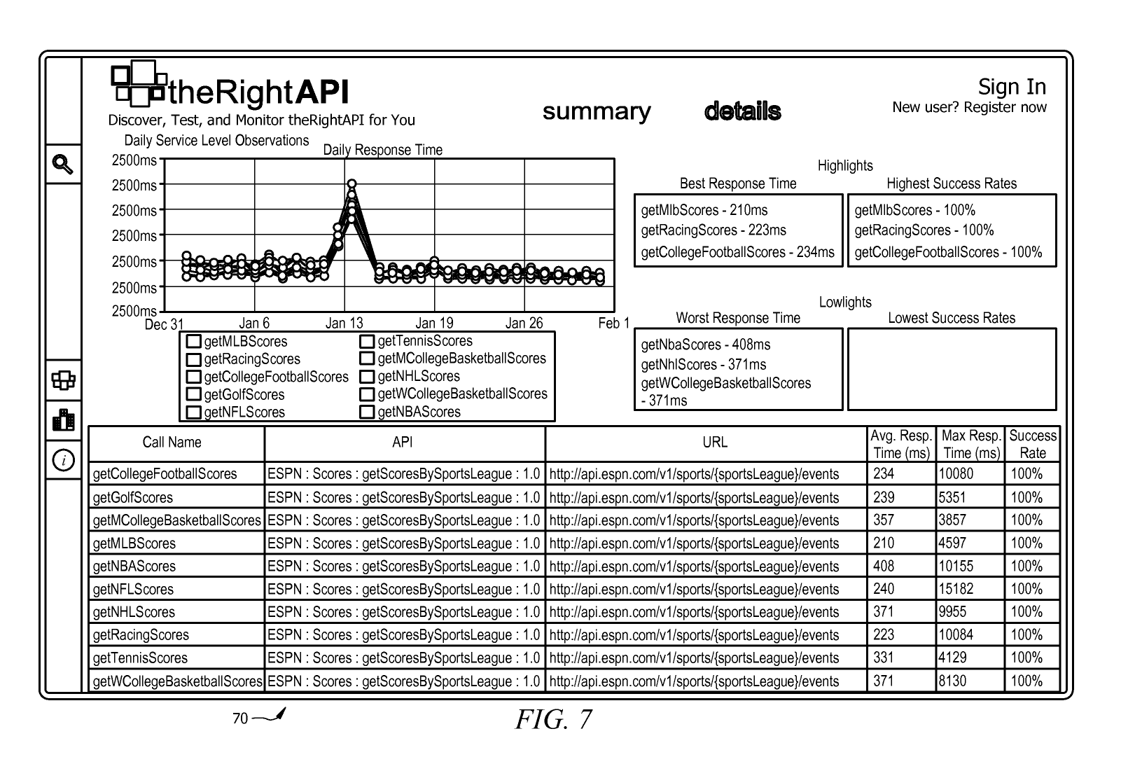

FIG. 7 provides a summary of test calls executed across different environments according to an embodiment of the present disclosure. A summary report may include information that may be included in a detailed API report (FIG. 6) in tabular or graphical form. In an embodiment of the present disclosure, the summary report may include a summary of the average API response time. The summary report also may provide highlights, such as best response times and highest success rates. Conversely, the summary report may provide lowlights, such as worst response times and lowest success rates. However, other summary data may be included in a summary API without departing from the present disclosure.

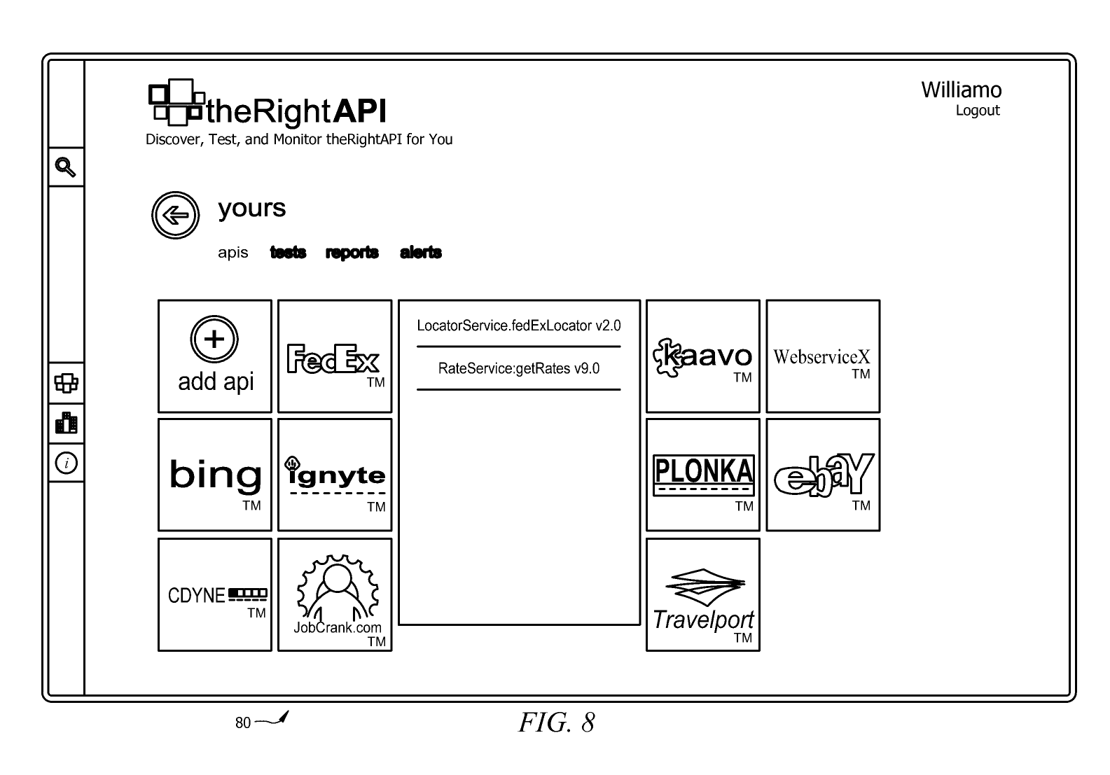

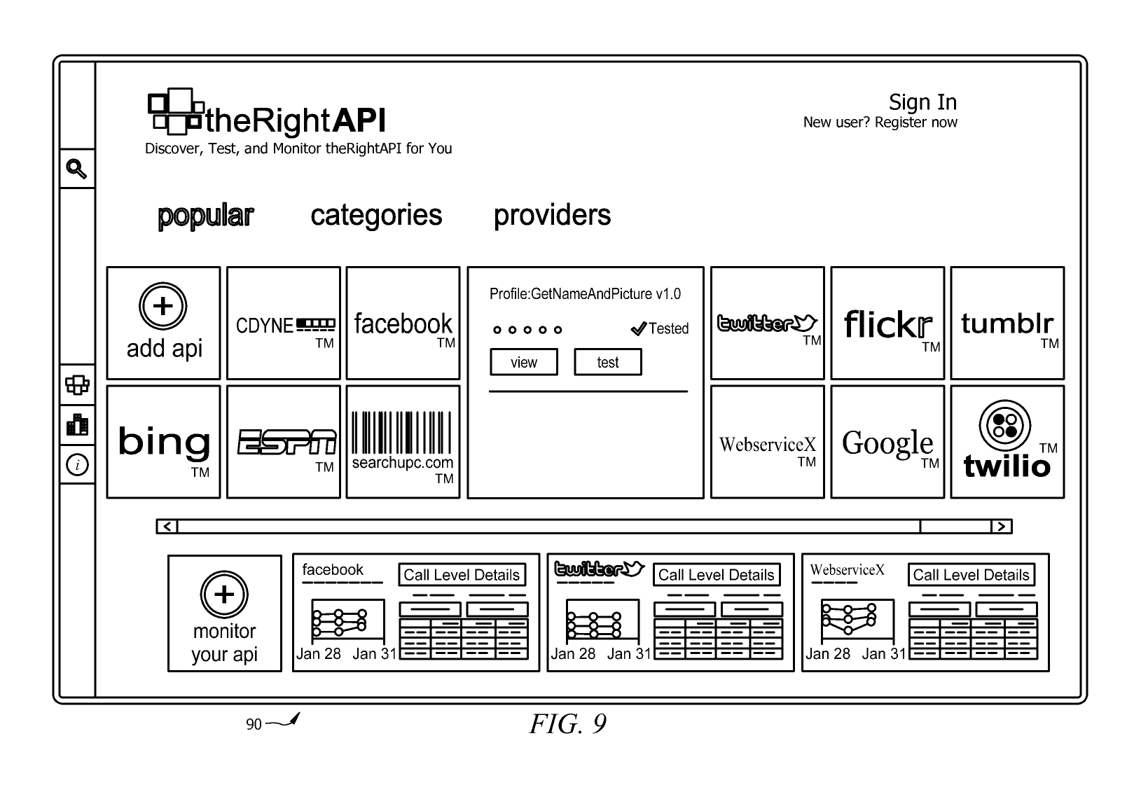

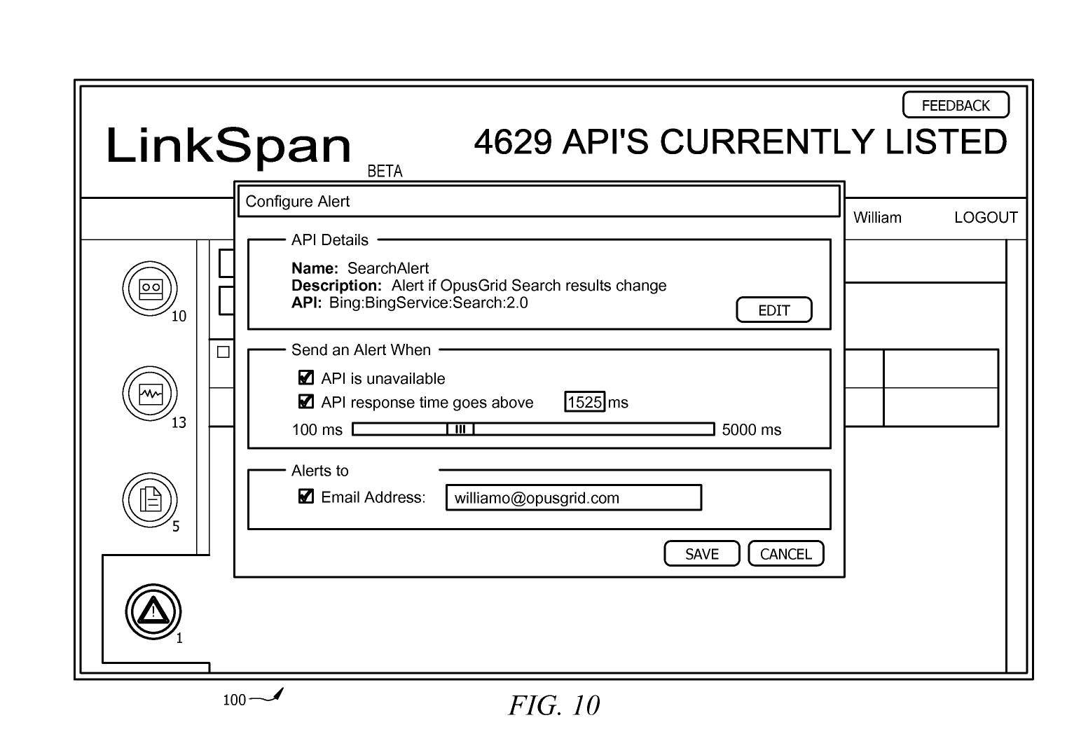

Other embodiments of the present disclosure may provide for an API dashboard that may include a listing of a user's APIs at any given time. An example of an API dashboard according to an embodiment of the present disclosure is depicted in FIG. 8. FIG. 8 depicts a view of selected APIs that are distributed across multiple public and private systems through a single console according to an embodiment of the present disclosure. From this dashboard, a user may import, discover, configure and/or remove APIs using buttons, hyperlinks, or other similar selection mechanisms. If a user wishes to discover APIs, the user may be presented with a screen such as that depicted in FIG. 9. The user may elect to discover APIs and filter possible APIs based on various selection criteria, including but not necessarily limited to, cost, provider, API name, user rating, average response time, and/or maximum response time. A user may make various sub-selections within the selection criteria (as depicted with respect to cost and API name in FIG. 10). After applying selection criteria, the user may be presented with various APIs meeting his/her criteria as depicted in FIG. 9. It should be appreciated that APIs may be compared and selected based on various factors such as functionality, price and/or performance in contrast to prior API management where the protocol and security model alone generally drove the API decision for a developer. Each API may have an “add API” button associated with it so that if a user wishes to add an API, he/she may select the button associated with the desired API to add it to the API dashboard. An API dashboard as depicted in FIG. 8 may include table 805 having several columns that may include but are not necessarily limited to, provider name, API name, method, version and/or description. However, it should be appreciated that more or fewer columns may be included in table 805 without departing from the present disclosure. Further, the columns may be arranged in a different order without departing from the present disclosure.

It also should be appreciated that a user may elect to configure alerts to further assist in managing API interactions according to embodiments of the present disclosure. FIG. 10 depicts creation of an API alert according to an embodiment of the present disclosure. In this embodiment, a user may select an API, and details about the API may be provided, including but not limited to, the API, name and description. Once an API has been selected to be included in an alert, the user may configure the alert based on various options. For example, the user may wish to be alerted when the API is unavailable and/or when the API response time goes above a certain specified time. However, the user may be provided with other options without departing from the present disclosure. The user may also decide how to receive API alerts, such as via email (by providing an email address), SMS messaging or other similar communication mechanisms.

It should be appreciated that various network types may be used in managing API interactions occurring interchangeably in the cloud and on premises according to embodiments of the present disclosure. Networks may include but are not necessarily limited to local area networks (LANs), wide area networks (WANs), wired or wireless Ethernet, Internet, cellular connections, as well as serial, parallel, USB or other similar connections. It also should be appreciated that routers may be incorporated into systems according to embodiments of the present disclosure to facilitate communication between networks, and switches may be connected to routers to join communication lines from computers. However, networking devices other than routers or switches may be used without departing from the present disclosure. Further, multiple network devices may be combined into a single network device in systems according to embodiments of the present disclosure.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A system for managing API interactions interchangeably across a plurality of environments comprising:
at least one local server storing at least one item of user-specific data in at least one local relational datastore and storing at least one item of user-specific data in at least one cloud-based datastore; and
a portal to access the at least one local server,
wherein the at least one local server selectively accesses the at least one local relational datastore and the at least one cloud-based datastore to discover and evaluate APIs.

2. The system of claim 1 wherein the at least one network is selected from the group comprising:
local area network (LAN), wide area network (WAN), wired Ethernet, wireless Ethernet, Internet, cellular connection, serial connection, parallel connection, and USB connection.

3. A method for managing API interactions interchangeably across a plurality of environments comprising:
monitoring to provide for service-level observations as proxy for what the API user is experiencing;
testing to simulate a call to an API and evaluate the results;
brokering to facilitate a connection between an application and the API and provide a single view of the multiple environments; and
storing data selectively across relational and non-relational datastores,
wherein each of the steps is performed through accessing one or more local servers over a network.

4. The method of claim 3 wherein the plurality of environments comprises a plurality of cloud environments.

5. The method of claim 3 wherein the plurality of environments comprises a combination of on premises and cloud environments.
